(19) United States
(12) Patent Application Publication
(10) Pub. No.: US 2021/0245679 A1
(43) Pub. Date: Aug. 12, 2021

(54) MULTIPURPOSE ORNAMENT DEVICE AND ATTACHMENT MECHANISM

(71) Applicant: Jonathan Anwar Griffie, Bowie, MD (US)

(72) Inventor: Jonathan Anwar Griffie, Bowie, MD (US)

(21) Appl. No.: 16/997,545

(22) Filed: Aug. 19, 2020

Related U.S. Application Data
(60) Provisional application No. 62/972,327, filed on Feb. 10, 2020.

(51) Int. Cl. B60R 13/00; G09F 21/04

(52) U.S. Cl. CPC B60R 13/005; G09F 21/04

(57) ABSTRACT

An ornament including an ornament body and an attachment assembly for attaching the ornament body to other structures is provided. In some embodiments, the ornament body includes a two-dimensional or three-dimensional representation of a human uterus and associated organs. The attachment assembly may be adapted to attach the ornament body to the bumper hitch of an automobile or truck, to the top of an automobile radio antenna, to a wall, and/or to other structures. The ornament may also be adapted to rest on a surface such as a shelf or desktop.

### CROSS-REFERENCE TO RELATED APPLICATIONS

This application claims priority to U.S. Provisional Application No. 62/972,327 filed Feb. 10, 2020, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to ornaments, including ornaments with visual representations of human uteruses.

### BACKGROUND

Automobiles are commonly decorated with various ornaments, including ornaments that may hang down from a vehicle's bumper hitch, that may be attached to the tip of a vehicle's radio antenna, that may hang down from a vehicle's rearview mirror, and other types of ornaments that may be configured in other ways with a vehicle.

Some such ornaments may be designed to be entertaining or funny. In one example of this as is known in the art, an ornament may include a visual representation of human testicles, that when configured to hang freely from a vehicle's bumper hitch, may provide a visually entertaining appearance that the vehicle includes its own testicles.

However, a female counterpart of this ornament does not exist.

Accordingly, there is a need for an ornament that provides an entertaining visual representation of a human uterus, and that when configured with a vehicle, provides the appearance that the vehicle includes its own uterus.

### SUMMARY

According to one aspect, one or more embodiments are provided below for an ornament adapted to be connected to a vehicle. The ornament may include a body portion including a decorative portion including a representation of a human uterus. The ornament also may include an attachment mechanism coupled to the body portion and adapted to attach the body portion to a vehicle.

In another embodiment, the decorative portion is two-dimensional or three-dimensional.

In another embodiment, attachment mechanism includes a loop, a hook, a clamp, a post, and/or a bolt.

In another embodiment, the decorative portion includes a representation of at least one of a fundus, a left fallopian tube, a right fallopian tube, a left ovary, a right ovary, left fimbriae, and right fimbriae.

In another embodiment, the attachment mechanism is adapted to hold the representation of a human uterus in an upright position.

In another embodiment, the body portion includes a top and a bottom, and the attachment mechanism is coupled to the top of the body portion.

In another embodiment, the top of the body portion includes an opening and the attachment mechanism is coupled to the opening.

In another embodiment, the body portion includes a front and a back, and the attachment mechanism is coupled to the back of the body portion.

In another embodiment, the representation of the human uterus is anatomically accurate.

According to another aspect, the present description includes an ornament that may include a body portion including a decorative portion. The decorative portion may consist of a representation of a human uterus. The ornament also may include an attachment mechanism coupled to the body portion and adapted to attach the body portion to a vehicle.

In another embodiment, the decorative portion further consists of a representation of at least one of a fundus, a left fallopian tube, a right fallopian tube, a left ovary, a right ovary, left fimbriae, and right fimbriae.

In another embodiment, the representation of the human uterus and of the at least one of a fundus, a left fallopian tube, a right fallopian tube, a left ovary, a right ovary, left fimbriae, and right fimbriae are anatomically accurate.

In another embodiment, the attachment mechanism includes at least one of a loop, a hook, a clamp, a post, and a bolt.

According to another aspect, the present description includes an ornament that consists of a body portion including a decorative portion. The decorative portion may consist of a representation of a human uterus, a fundus, a left fallopian tube, a right fallopian tube, a left ovary, and a right ovary. The ornament also may include an attachment mechanism coupled to the body portion and adapted to attach the body portion to a trailer hitch of a vehicle.

In another embodiment, the ornament includes a height of 5 cm to 8 cm and a width of 14 cm to 24 cm.

In another embodiment, the representation of the human uterus, the fundus, the left fallopian tube, the right fallopian tube, the left ovary, and the right ovary are anatomically accurate.

In another embodiment, the attachment mechanism includes at least one of a loop, a hook, a clamp, a post, and a bolt.

In another embodiment, the body portion includes a top and a bottom, the top of the body portion includes an opening and the attachment mechanism is coupled to the opening.

Other aspects and advantages of the invention will be apparent from the following description and the appended claims.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows a front schematic of an ornament in accordance with exemplary embodiments hereof;

FIG. 2 shows a rear schematic of an ornament in accordance with exemplary embodiments hereof;

FIG. 3 shows aspects of an ornament configured with a vehicle in accordance with exemplary embodiments hereof;

FIG. 4 shows aspects of an ornament body portion and attachment assembly in accordance with exemplary embodiments hereof;

FIG. 5 shows aspects of an ornament body portion and attachment assembly in accordance with exemplary embodiments hereof; and

FIG. 6 shows aspects of an ornament body portion and attachment assembly in accordance with exemplary embodiments hereof;

### DETAILED DESCRIPTION OF EXEMPLARY EMBODIMENTS

In general, the ornament 10 of the current invention includes a representation of a human uterus and its associated organs. In some embodiments, the ornament 10 includes the general shape of a human uterus and its associated organs so that it may be recognizable as such. In some embodiments, the ornament 10 includes representations of at least some of the major components of a human uterus and its associated organs. In general, it is preferable that a person of ordinary skill in the art will recognize the ornament 10 as a representation of a human uterus and its associated organs when viewing the ornament 10. However, it is understood that the ornament 10 need not include an exact replica of a human uterus and its associated organs as will be described herein.

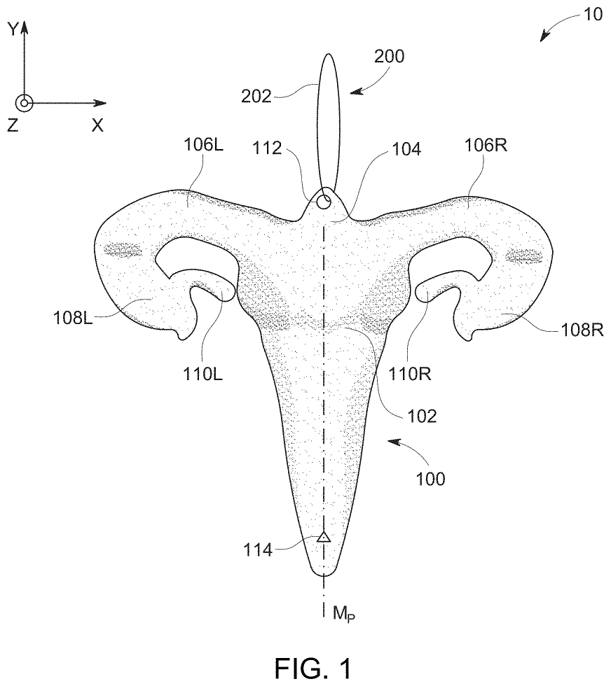

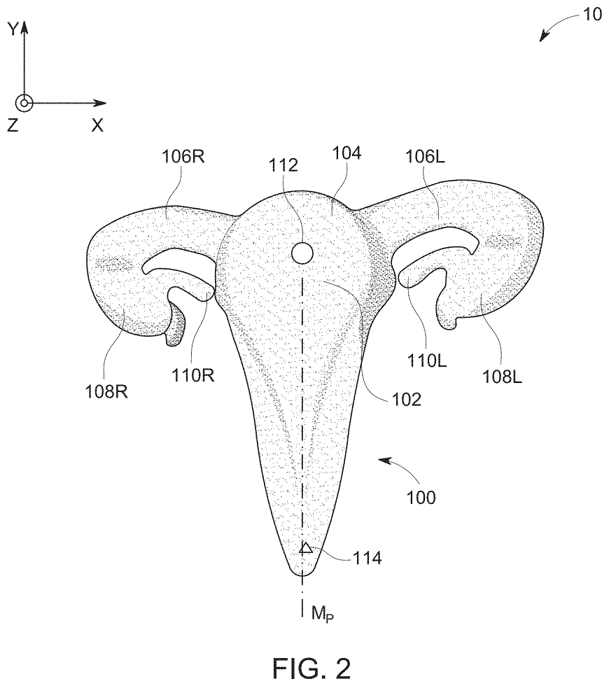

In one exemplary embodiment hereof as shown in FIGS. 1 and 2, the ornament 10 includes a body portion 100 and an attachment assembly 200. In general, the body portion 100 includes a representation of a human uterus and its associated organs, and the attachment assembly 200 secures the body portion 100 to another apparatus (e.g., an automobile bumper hitch, tip of an automobile antenna, an automobile rearview mirror, etc.).

Body Portion 100

In some embodiments, the body portion 100 includes decorative portions that visually represent the following uterine components and/or associated organs (without limitation): a uterus 102, a fundus 104, a left fallopian tube 106L, a right fallopian tube 106R, a left ovary 108L, a right ovary 108R, left fimbriae 110L, and right fimbriae 110R. It is understood that the body portion 100 need not include all of the above listed uterine components and/or associated organs, and that the body portion 100 need only include visual representations of uterine components and/or associated organs sufficient for the body portion 100 to be recognized as such. For example, the body portion 100 may not necessarily include representations of the left and/or right fimbriae 110L, 110R and still be recognizable as a human uterus.

It also is understood that the body portion 100 may include additional components of the human uterus and/or other associated organs, and that the scope of the ornament 10 is not limited by the components of the human uterus and/or associated organs that it may include as long as the ornament 10 may be generally recognizable as including a visual representation of a human uterus. For example, in some embodiments the body portion 100 may include a visual representation of eggs within the ovaries 108L, 108R.

In some embodiments, the body portion 100 is generally anatomically accurate in its representation of the human uterus and its associated organs. For the purposes of this specification, the term anatomically accurate means that the anatomical elements are shaped and proportionally sized with respect to one another within an accuracy of 10%. For example, the size of the uterus 102, fundus 104, left fallopian tube 106L, right fallopian tube 106R, left ovary 108L, right ovary 108R, left fimbriae 110L, and/or right fimbriae 110R may be generally anatomically accurate and correctly shaped and sized proportional to one another within 10%. However, in other embodiments the body portion 100 is not necessarily anatomically accurate in its representation of the human uterus and its associated organs. For example, the body portion 100 may include an abstract representation of the human uterus and its associated organs.

In some embodiments, some aspects of the body portion 100 may be generally anatomically accurate while other aspects of the body portion 100 may not necessarily be anatomically accurate. For example, the uterus 102 may be sized and shaped accurately but the left and/or right fallopian tubes 106L, 106R may not necessarily be so (e.g., the fallopian tubes 106L, 106R may be larger or smaller and not accurately proportional to the uterus 102).

In some embodiments, some aspects of the body portion 100 may be anatomically accurate while other aspects may include abstract representations. For example, the uterus 102 may be anatomically accurate and the fallopian tubes 106L, 106R may be abstract renditions.

In another embodiment, the relative positioning of the uterus 102, fundus 104, left fallopian tube 106L, right fallopian tube 106R, left ovary 108L, right ovary 108R, left fimbriae 110L, and/or right fimbriae 110R may be generally anatomically accurate with respect to one another, while in other embodiments at least some of the positionings of the elements 102, 104, 106L, 106R, 108L, 108R may not necessarily be accurate with respect to one another.

In some embodiments, the body portion 100 may be generally symmetrical about its median plane Mp (as shown in FIGS. 1-2) while in other embodiments, the body portion 100 need not be symmetrical.

In some embodiments, the body portion 100 include a representation of a human uterus and associated organs that may include portions that may be altered (e.g., elongated, reduced in size, warped, skewed, etc.) in one or more directions. For example, the human uterus 102 may be reduced in size along the Y-axis and the fallopian tubes 106L, 106R may be elongated along the X-axis. It is understood that this example is provided for demonstration and that any elements 102, 104, 106L, 106R, 108L, 108R and/or portion(s) of the body portion 100 may be altered in any way (e.g., elongated, reduced in size, warped, skewed, etc.) along the X-axis, Y-axis and/or Z-axis, and in any combinations thereof

In some embodiments, the body portion 100 may be three-dimensional such that when viewed from the side the body portion 100 may include a sufficient width that may represent a uterine width. In other embodiments, the body portion 100 may be two-dimensional such that when viewed from the side the body portion 100 includes a width only of the two-dimensional material that it may be constructed from (e.g., a width of a sheet of compressed cardboard).

In some embodiments, the body portion 100 is sized anatomically accurately with the uterus 102 measuring about 5 cm-8 cm tall and 3 cm-4 cm wide at the top, and the fallopian tubes 106L, 106R measuring about 7 cm-12 cm in length and about 1 cm in diameter. In other embodiments, the body portion 100 may be smaller or larger depending on the desired size of the ornament 10. For example, the body portion 100 may be 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 160%, 170%, 180%, 190%, 200%, 210%, 220%, 230%, 240%, 250%, 260%, 270%, 280%, 290%, 300%, 325%, 350%, 375%, 400%, 450%, 500%, or other percentages of the anatomically correct dimensions.

In some embodiments, the body portion 100 may comprise plastic, rubber, wood, paper, cardboard, metal, composite materials, other polymers, other materials, and any combination thereof. In some embodiments, the materials may comprise glow-in-the-dark materials. The body portion 100 may be molded, sculpted, carved, or formed using other production techniques. The body portion 100 may be formed as a single piece or may be formed as multiple pieces that may be combined to form the body portion 100.

In some embodiments, one or more portions of the body portion 100 may be painted, dyed, or otherwise colored during or after the production process. In some embodiments, this coloring may be solid. In some embodiments, some elements of the body portion 100 may be colored the same or differently compared to other elements. For example, the uterus 102 may be colored a different color compared to the fallopian tubes 106L, 106R.

In some embodiments, some portions of the body portion 100 may include colored contours, shading, highlighting, outlining and/or other visual effects that may help to visually define the various elements 102, 104, 106L, 106R, 108L, 108R of the body portion 100 and to distinguish one element from another.

In other embodiments, some portions of the body portion 100 may be transparent, opaque, translucent, colored translucent, multi-colored translucent (e.g., with different elements translucently colored using different or the same colors), and/or any combination thereof. In some embodiments, some elements of the body portion 100 may be colored solid while other portions may be transparent, translucent, colored translucent and any combination thereof. In some embodiments, the body portion 100 may include illumination elements 114 that may illuminate the body portion 100. For example, the body portion 100 may include LEDs 114 embedded within the body portion 100, coupled to the outside surface of the body portion 100, and/or otherwise configured to illuminate any portion of the body portion 100. In some embodiments, the illumination elements 114 may illuminate any transparent and/or translucent elements 102, 104, 106L, 106R, 108L, 108R from within so that the elements 102, 104, 106L, 106R, 108L, 108R may appear to glow. The illumination elements 114 of FIGS. 1-2 are shown as being located towards the bottom of the uterus 102, but it is understood that the illumination elements 114 may be positioned anywhere within, on, or otherwise in close proximity to the body portion 100 to adequately illuminate the body portion 100 as required. As will be described in other sections, additional illumination elements may be configured with the attachment assembly 200.

In some embodiments, the body portion 100 may include decorative patterns on at least some portions of its surface. In other embodiments, some portions of the body portion's surfaces may include insignia, emblems, logos, letterings, words, sayings, mottos, or other visual elements.

In some embodiments, the body portion 100 may include a face or other elements that may add entertainment value to the ornament. For example, the uterus 102 may include facial markings and/or the fallopian tubes 106L, 106R may each include hands. It is understood that is example is meant for demonstration and that the body portion 100 may include other types of similar type markings.

In some embodiments, the ornament 10 may include two or more body portions 100, uteruses 102, funduses 104, left fallopian tubes 106L, right fallopian tubes 106R, left ovaries 108L, right ovaries 108R, left fimbriae 110L, right fimbriae 110R, and/or any other elements with or without any of the characteristics as described above.

Attachment Assembly 200

In one exemplary embodiment hereof, the attachment assembly 200 includes an attachment mechanism 202 that may be adapted to attach the body portion 100 to another apparatus such as a vehicle (e.g., an automobile or truck) or other apparatuses and/or structures (e.g., to a wall). In some embodiments, the body portion 100 includes an attachment element 112 with which the attachment mechanism 202 may be configured and generally attached.

In one embodiment, the body portion's attachment element 112 may include an opening (see FIG. 1) and the attachment mechanism 202 may include an elongated element that may pass through the opening 112. For example, the attachment mechanism 202 may include a chain, a string, a band, a loop, a carabiner, a hook, a clasp, a wire, other types of attachment mechanisms and any combination thereof. In one example implementation, the attachment mechanism 202 includes a metal chain adapted into a loop that passes through the opening 112 as shown in FIG. 1. It may be preferable that the opening 112 be generally positioned in the upper portion of the body portion 100 as shown so that the body portion 100 may be oriented vertically and right-side-up when hanging from the attachment mechanism 202, but this may not be required.

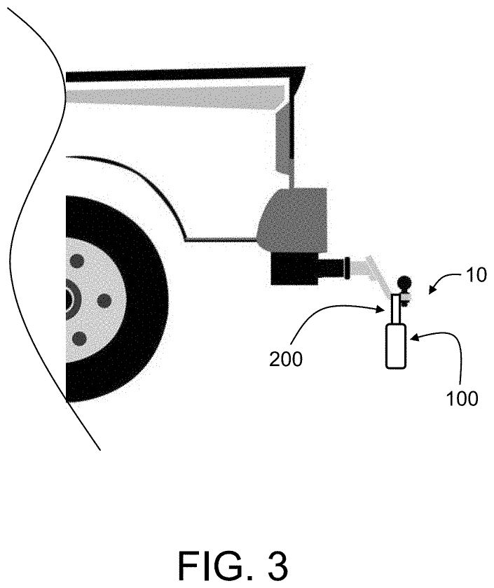

In some embodiments, the attachment mechanism 202 is adapted to be coupled with a component of or associated with a vehicle such as (without limitation), a bumper hitch (also referred to as a trailer hitch or tow hitch), a bumper, a rearview mirror, a license plate assembly, an antenna, any other component of or associated with a vehicle or any combination thereof. In one example implementation as shown in FIG. 3, the ornament 10 is configured with a bumper hitch of a vehicle. It is understood that the ornament 10 may be attached to any component of type of vehicle including, without limitation, an automobile, a truck, a semi-trailer truck, a motorcycle, a cart, a golf cart, a scooter, a moped, a bicycle, a tricycle, a unicycle, a boat, a helicopter, a plane, any other type of vehicle and any combination thereof

In some embodiments, the attachment mechanism 202 is adapted to be coupled with a structure such as a wall, a door, a fence, a shelf, a desktop, a railing, other types of structures and any combination thereof.

In some embodiments, it may be preferable that the attachment mechanism 202 be coupled with the body portion 100 so that the body portion 100 may swing freely (e.g., may swing freely while hanging from the bumper hitch of a vehicle). In other embodiments, the attachment mechanism may hold the body portion 100 in a fixed position. In other embodiments, the attachment mechanism 202 may be semi-rigid and/or malleable (e.g., a bendable wire) so that the position of the body portion 100 may be adjustable by adjusting (e.g., bending) the shape, form or positioning of the attachment mechanism 202.

In some embodiments, the attachment mechanism 202 may be releasable so that the body portion 100 may be removed from and subsequently reattached to the attachment mechanism 202 (e.g., the attachment mechanism 202 may include a loop of chain with a clasp that may open and close the loop).

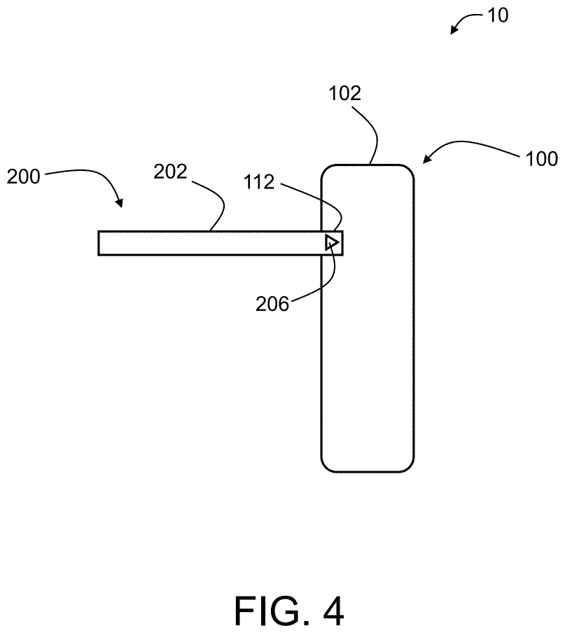

In one embodiment, the body portion's attachment element 112 may include an opening (e.g., on the rear side of the ornament 10 as shown in FIG. 2) and the attachment mechanism 202 may include an elongated element that may be received partially into the opening and held therein. For example, the attachment mechanism 202 may include a post, a rod, a tab, a shaft, a dowel, other types of attachment mechanism 202 and any combination thereof. In one example implementation as shown in FIG. 4, the attachment mechanism 202 includes a metal post with a distal end inserted into the opening 112 and held therein (e.g., by pressure fit, circumferential threads, adhesive, etc.), and a proximal end that may be attached to another apparatus or structure (e.g., a bumper of a vehicle).

The attachment mechanism 202 may comprise metal, plastic, rubber, wood, other polymers, other materials, and any combination thereof.

The attachment mechanism 202 may include a bolt, a screw, a clamp, a clasp, a nail, adhesive, welding, tape, other types of attachment mechanisms, and any combination thereof to be attached to the vehicle component (e.g., bumper hitch) and/or other structure(s) (e.g., wall). It may be preferable that the attachment mechanism 202 be releasable so that the ornament 10 may be removed and subsequently reattached as desired.

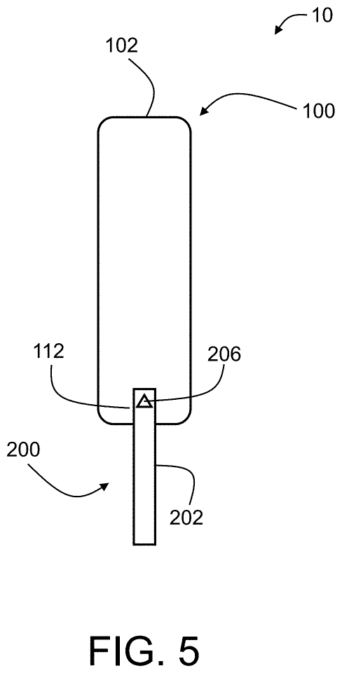

In another embodiment, the opening 112 may be generally positioned on the bottom of the body portion 100 so that the body portion 100 may be configured with an attachment mechanism 202 from below and held generally upright. This is shown in FIG. 5. In one example of this, the attachment mechanism 202 may include the top of a vehicle's radio antenna and the body portion 100 may be configured thereon.

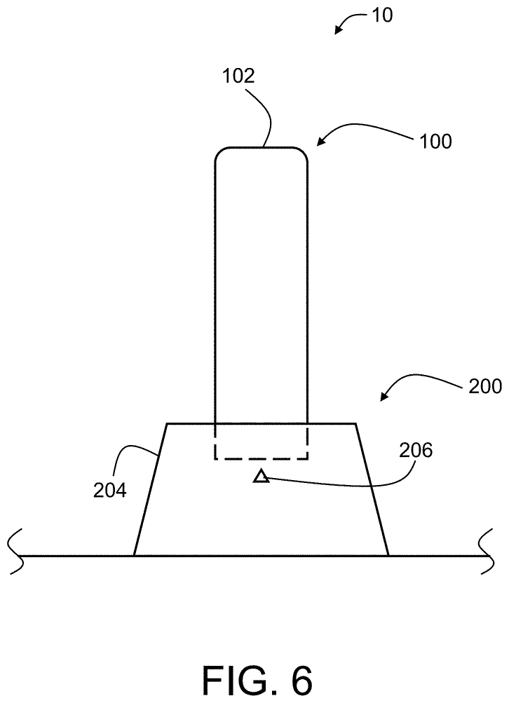

In another embodiment, the ornament 10 is adaptable to rest upright on a generally flat surface such as a shelf, desktop, tabletop, dashboard, other generally flat surfaces and any combination thereof. In one embodiment, the body portion 100 may include a generally flat lower surface upon which it may rest and stand upright. In another embodiment as shown in FIG. 6, the attachment assembly 200 includes a stand 204 upon which the body portion 100 may rest and be held generally upright and right-side-up. In other embodiments, the body portion's bottom surface and/or the bottom surface of the stand 204 may include hook and loop material, double-sided tape, adhesive or other types of attachment means to secure the body portion 100 and/or the stand 204 to the surface upon which it may rest.

In any of the above embodiments, the attachment assembly 200 may include one or more illumination elements 206 (e.g., LEDs) that may transmit light onto and/or into the body portion 100. For example, as shown in FIGS. 4-5, the illumination elements 206 may be coupled with the attachment mechanism 202. In another example as shown in FIG. 6, the base 206 may include the illumination elements 206. In some embodiments, if some portion(s) of the body portion 100 are transparent and/or translucent, the light provided by the illumination elements 206 may transmit into the body portion 100 so that the body portion 100 may generally glow. In some embodiments, the illumination elements 206 may provide white light, colored light, and/or any combination thereof. Power may be provided to the illumination elements 206 via rechargeable batteries, photovoltaic elements, other types of power supplies and any combination thereof In some embodiments, the illumination elements 206 may be provided in addition to or in lieu of the illumination elements 114 of the body portion 100.

In some embodiments, the attachment assembly 200 may include a plurality of attachment mechanisms 202 of any type and in any combination.

It is understood that the above described attachment mechanisms 202 and techniques are meant for demonstration and that the body portion 100 may be attached to another apparatus and/or structure using any type of adequate attachment mechanisms 202 and techniques, and that the scope of the ornament 10 is not limited in any way by the type attachment mechanism(s) 202 and/or techniques used to configure the ornament 10 to another apparatus and/or structure.

It also is understood that any aspect and/or element of any embodiment described herein or otherwise may be combined in any way with any other aspect and/or element of any other embodiment described herein or otherwise to form an additional embodiment that also is within the scope of the ornament 10.

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An ornament, comprising:
a body portion including a decorative portion; and
an attachment mechanism coupled to the body portion and adapted to attach the body portion to a vehicle;
wherein the decorative portion comprises a representation of a human uterus.

2. The ornament of claim 1 wherein the decorative portion is two-dimensional or three-dimensional.

3. The ornament of claim 1 wherein the attachment mechanism includes at least one of a loop, a hook, a clamp, a post, and a bolt.

4. The ornament of claim 1 wherein the decorative portion further comprises a representation of at least one of a fundus, a left fallopian tube, a right fallopian tube, a left ovary, a right ovary, left fimbriae, and right fimbriae.

5. The ornament of claim 1 wherein the attachment mechanism is adapted to hold the representation of a human uterus in an upright position.

6. The ornament of claim 1 wherein the body portion includes a top and a bottom, and the attachment mechanism is coupled to the top of the body portion.

7. The ornament of claim 6 wherein the top of the body portion includes an opening and the attachment mechanism is coupled to the opening.

8. The ornament of claim 1 wherein the body portion includes a front and a back, and the attachment mechanism is coupled to the back of the body portion.

9. The ornament of claim 1 wherein the representation of the human uterus is anatomically accurate.

10. The ornament of claim 4 wherein the representation of the human uterus and of the at least one of a fundus, a left fallopian tube, a right fallopian tube, a left ovary, a right ovary, left fimbriae, and right fimbriae are anatomically accurate.

11. An ornament, comprising:
a body portion including a decorative portion; and
an attachment mechanism coupled to the body portion and adapted to attach the body portion to a vehicle;
wherein the decorative portion consists of a representation of a human uterus.

12. The ornament of claim 12 wherein the decorative portion further consists of a representation of at least one of a fundus, a left fallopian tube, a right fallopian tube, a left ovary, a right ovary, left fimbriae, and right fimbriae.

13. The ornament of claim 13 wherein the representation of the human uterus and of the at least one of a fundus, a left fallopian tube, a right fallopian tube, a left ovary, a right ovary, left fimbriae, and right fimbriae are anatomically accurate.

14. The ornament of claim 13 wherein the attachment mechanism includes at least one of a loop, a hook, a clamp, a post, and a bolt.

15. An ornament, consisting of:
a body portion including a decorative portion; and
an attachment mechanism coupled to the body portion and adapted to attach the body portion to a trailer hitch of a vehicle;
wherein the decorative portion consists of a representation of a human uterus, a fundus, a left fallopian tube, a right fallopian tube, a left ovary, and a right ovary.

16. The ornament of claim 16 wherein the ornament includes a height of 5 cm to 8 cm and a width of 14 cm to 24 cm.

17. The ornament of claim 16 wherein the representation of the human uterus, the fundus, the left fallopian tube, the right fallopian tube, the left ovary, and the right ovary are anatomically accurate.

18. The ornament of claim 16 wherein the attachment mechanism includes at least one of a loop, a hook, a clamp, a post, and a bolt.

19. The ornament of claim 16 wherein the body portion includes a top and a bottom, the top of the body portion includes an opening and the attachment mechanism is coupled to the opening.
